(19) United States
(12) Patent Application Publication
(10) Pub. No.: US 2015/0279192 A1
(43) Pub. Date: Oct. 1, 2015

(54) Tire Inflation Device Capable of Detecting and Recording Tire Pressure in Real Time

(71) Applicant: LEMATEC CO., LTD., Changhua City (JP)

(72) Inventor: Vic CHEN, Changhua City (TW)

(21) Appl. No.: 14/296,150

(22) Filed: Jun. 4, 2014

(30) Foreign Application Priority Data
Apr. 1, 2014 (TW) 103205605

(51) Int. Cl. G08B 21/18; B60C 23/04

(52) U.S. Cl. CPC G08B 21/182; B60C 23/0433

(57) ABSTRACT

A tire inflation device capable of detecting and recording a tire pressure in real time is formed of a gas supply unit, a sensing unit, a control unit, and a communication unit. The gas supply unit is to inflate a tire with a gas. The sensing unit is mounted to the gas supply unit for detecting the tire pressures of the tires and then outputting sensing signals. The control unit is connected with the sensing unit for receiving the sensing signals and converting them into tire-pressure data. The communication unit is connected with the control unit for transmitting the tire-pressure data to a signal recording device.

### BACKGROUND OF THE INVENTION

1. Field of the Invention

The present invention relates generally to a tire inflation device and more particularly, to a tire inflation device capable of detecting and recording a tire pressure in real time.

2. Description of the Related Art

For more driving safety, the tires of various vehicles need to have sufficient tire pressures to keep the moving vehicles stable. When a vehicle needs maintenance, a tire pressure gauge is usually used for detecting the tire pressures of the tires. The tire pressure gauge is formed of a gas tube for connection with a tire and a gauge for detecting the pressure inside the gas tube. The tire pressure of the tire can be accessed through the gauge.

However, the aforesaid gauge could only detect the tire pressure of one single tire and a user needs to record it in other ways, i.e. recording the tire pressure by handwriting one by one, to know the tire pressure of the whole vehicle, thus leading to inconvenience and trouble. Besides, the user fails to completely record and gather statistics of the outcome of each maintenance.

### SUMMARY OF THE INVENTION

The primary objective of the present invention is to provide a tire inflation device, which can accurately detect and display a tire pressure and record and gather statistics of tire-pressure data to facilitate tire inflation and maintenance.

The foregoing objective of the present invention is attained by the tire inflation device formed of a gas supply unit, a sensing unit, a control unit, and a communication unit. The gas supply unit is to inflate a tire with a gas. The sensing unit is mounted to the gas supply unit for detecting the tire pressures of the tires and then outputting sensing signals. The control unit is connected with the sensing unit for receiving the sensing signals and converting them into tire-pressure data. The communication unit is connected with the control unit for transmitting the tire-pressure data to a signal recording device.

In light of the structure disclosed above, the sensing unit can synchronously detect the pressure of the gas in real time and displaying the tire-pressure data on the display unit or the signal recording device. The tire-pressure data of each tire can be recorded in and displayed on the signal recording device, so the signal recording device can further integrate or gather statistics of the tire pressures of the tires.

### BRIEF DESCRIPTION OF THE DRAWINGS

FIG. 1 is a block diagram of a preferred embodiment of the present invention.

FIG. 2 is a flow chart of the preferred embodiment of the present invention.

FIG. 3 is a perspective view of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiments is given by way of illustration only, thus being not limitative of the claim scope of the present invention.

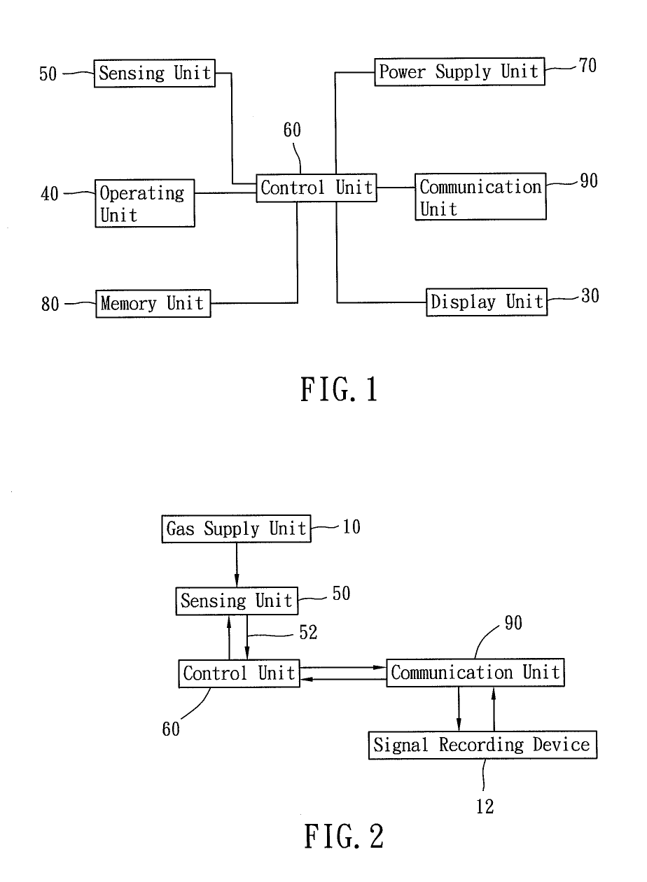

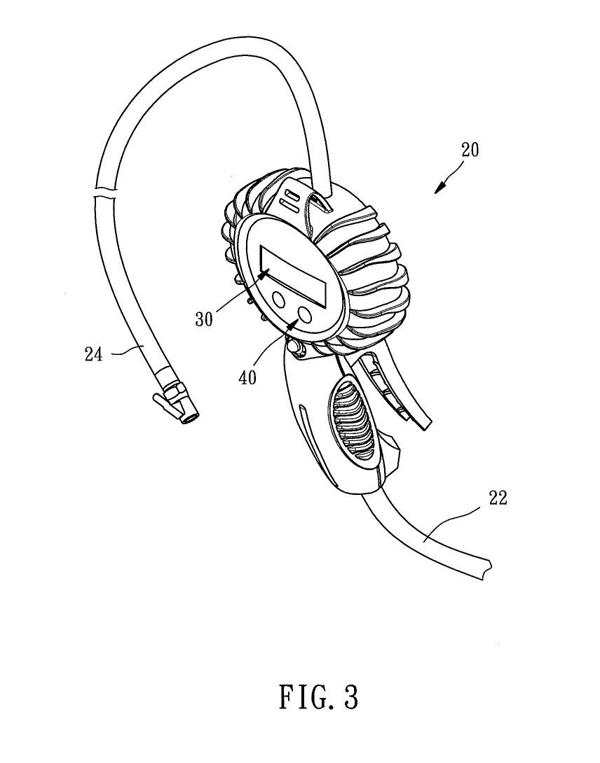

Referring to FIGS. 1-3, a tire inflation device capable of detecting and recording a tire pressure in real time in accordance with a preferred embodiment of the present invention is formed of a gas supply unit 10, a sensing unit 50, a control unit 60, and a communication unit 90. The detailed descriptions and operations of these elements as well as their interrelations are recited in the respective paragraphs as follows.

The gas supply device 10 is to inflate the tires with gas and includes a main body 20. The main body 20 includes a display unit 30 and an operating unit 40. The main body 20 includes a display unit 30 and an operating unit 40, the latter of which is for a user to operate. The main body 20 includes a gas passage (not shown) communicating with an intake tube 22 and an outtake tube 24. The intake tube 22 communicates with a compressed gas source (not shown). The outtake tube 24 is connected with a valve of a tire, through which the gas supply unit 10 can correctly and quickly transmit the compressed gas into the tire.

The sensing unit 50 is a gas pressure sensor and mounted inside the gas passage of the gas supply unit 10. In particular, the sensing unit 50 can be mounted to a position adjacent to the outtake tube 24 for accurately detecting the tire pressure of the tire into which the gas is actually charged, so the sensing unit 40 can output a sensing signal 52 as soon as detecting the tire pressure.

The control unit 60 is a microprocessor in this embodiment and electrically connected with the sensing unit 50 for receiving and converting the sensing signal 52 into tire-pressure data. The control unit 60 is also electrically connected with a power supply unit 70 and a memory unit 80. The power supply unit 70 is to provide electricity for the whole tire inflation device. In this embodiment, the memory unit 80 is an electrically erasable programmable read-only memory (EEPROM) as an example.

The communication unit 90 is a Bluetooth communication module in this embodiment and can be an equivalent as long as it can function as wireless communication. The communication unit 90 is electrically connected with a control unit 60 and can transmit the tire-pressure data to a signal recording device 12. In this embodiment, the signal recording device 12 is a smart phone and can run an application program installed therein for displaying and recording the tire-pressure data of each tire each time according to grouping.

When the gas supply unit 10 inflates the tire through the outtake tube 24, the sensing unit 50 can detect the pneumatic pressure in phase and in real time and display the tire-pressure data straight on the display unit 30 or the signal recording device 12 through the communication unit 90 to enable the user to conform whether the gas inflation is normal or not. When the tire is inflated with standard tire pressure, the tire-pressure data of each tire can be recorded and displayed on the display unit 30 and or the signal recording device 12, so the signal recording device 12 can further integrate or gather statistics of the status of the tire pressure of every tire.

It is worth mentioning that the memory unit 80 can save multiple sets of the tire-pressure data for classifying different clients' tire-pressure data or for gathering statistics of different maintenances and repairs.

What is claimed is:

1. A tire inflation device capable of detecting and recording a tire pressure in real time, comprising:
a gas supply device for inflating a tire with a gas;
a sensing unit mounted to the gas supply unit for detecting the tire pressure of the tire and outputting a sensing signal;
a control unit connected with the sensing unit for receiving the sensing signal and converting the sensing signal into tire-pressure data; and
a communication unit connected with the control unit for transmitting the tire-pressure data to a signal recording device.

2. The tire inflation device as defined in claim 1, wherein the gas supply unit comprises a main body, the main body having a display unit and an operable operating unit.

3. The tire inflation device as defined in claim 1, wherein the gas supply unit comprises a main body, the main body having an gas passage communicating with an intake tube and an outtake tube, the intake tube communicating with a compressed gas, the outtake tube being connected with the tire for transmitting the compressed gas into the tire correctly and quickly.

4. The tire inflation device as defined in claim 1, wherein the gas supply unit comprises a memory unit for saving multiple sets of the tire-pressure data for classifying different clients' tire-pressure data or for gathering statistics of different maintenances and repairs.

5. A tire-inflation method based on the tire inflation device defined in claim 1 comprising steps of:
a. making the gas supply unit charge a gas into the tire;
b. making the sensing unit detect the gas pressure in phase and in real time and displaying the tire-pressure data on a display unit or the signal recording device via the communication unit; and
c. making the signal recording device record and display the tire-pressure data.
